(19) United States
(12) Patent Application Publication
(10) Pub. No.: US 2005/0205690 A1
(43) Pub. Date: Sep. 22, 2005

(54) Holder for sample elements of, in particular for card samples

(75) Inventor: Christian Rommel, Emsdetten (DE)

Correspondence Address: MERCHANT & GOULD PC, P.O. BOX 2903, MINNEAPOLIS, MN, 55402-0903, US

(73) Assignee: Silfox Holding GmbH, Emsdetten (DE)

(21) Appl. No.: 10/517,196

(22) PCT Filed: Nov. 19, 2003
(86) PCT No.: PCT/DE03/03825

§ 371 Date: May 31, 2005

(30) Foreign Application Priority Data
Nov. 19, 2002 (DE) 102 54 003.9

(51) Int. Cl. B05B 9/03; A62C 13/62; A62C 13/66; A62C 35/58

(52) U.S. Cl. 239/304; 239/302; 239/305

(57) ABSTRACT

The invention relates to a holder for sample elements, in particular for card samples. The inventive holder comprises at least a holding body which passes through the recess or ring of a sample element or several sample elements and a reception area for the sample elements which comprises two holding bodies. At least one holding body is movable which makes it possible to obtain a closed ring-wise configuration when the holding body is closed and a configuration provided with a passage between the holding bodies in a charging position thereof. Said holding bodies are provided with at least one handgrip on the parts thereof opposed to the reception area.

The invention relates to a holder for sample elements according to the preamble of the main claim.

Holders for sample elements are known from practice, and these sample elements are a matter of, for example, color-sample cards on which the tones of the corresponding paints or varnishes are reproduced, or a matter of, for example, sample cards on which wall paints, wood glazes, floor laminates, furniture coatings or the like are displayed.

In the following, the innovation is described with reference to color-sample cards, whereby, however, the protective scope of the innovation is not limited, but rather it is to be made clear that the innovation relates to all additional holders for sample elements, for example product samples.

The known holders of color-sample cards have either a screw system, wherein a bolt is pushed through cutouts in the color cards or through eyelets of color cards and this bolt is provided at the ends with, for example, screw nuts or other locking elements, so that, once pushed onto the bolt, the color cards can no longer unintentionally fall off this locking bolt; or the known holders use a ring in the manner of a key ring onto which the color-sample cards are threaded.

These solutions, already known in practice and in themselves already well-proven, have the disadvantage that they are quite complicated to operate, since it must be kept in mind that, in general, very many different color-sample cards are to be arranged on a holder and, for example in the case of color-sample cards for automobile colors, these color-sample cards must be exchanged relatively frequently, in order to cope with the constantly changing colors in the automobile industry. This exchanging and updating of color-sample cards is complicated, since upon the opening of, for example, a color-card holder of a screw-type design, first of all the color cards not requiring change must be set aside in the correct sequence, in order to arrive at the color cards to be changed, which can, for example, be situated in the middle of a whole stack of color cards located in the holder. This operation is time-consuming and there exists the danger that the color cards first laid aside and later reinstalled can easily become mixed up, so that a subsequent sorting of the color-sample cards placed onto the holder is possibly still necessary.

The invention is based on the object of developing a holder for sample elements, as for example color-sample cards, that is extremely simple to operate and has a simple and cost-effective design.

This object forming the basis of the invention is achieved through the teaching of the characterizing portion of the main claim.

Expressed in other words, a holder for sample elements is proposed, which holder consists of at least two holding bodies, at least one of these holding bodies being movably actuable in order to open the holding body formed in the manner of a ring, so that sample elements can be either placed onto the holder or removed from it, the holder displaying at least one handgrip for better manipulation.

That the holding bodies are configured “in the manner of a ring” does not mean that they are circular, but rather that they form a closed reception region, so that the received sample elements cannot fall off or rather cannot fall off unintentionally.

Advantageous configurations of the invention are explained in the dependent claims.

In an advantageous configuration, situated between the handgrips and the reception region is a joint, so that an especially simple opening and closing of the holder is made possible.

In an advantageous configuration, the joint guiding the two holding bodies is spring-loaded, so that the holding bodies are closed when no stress is applied.

In an advantageous configuration, the closed holding bodies approximately form an oval, in order to make possible a simple operation of the holder.

In an advantageous configuration, the end faces of the holding bodies facing each other have a complementary beveled shape in the passage region, in order to effect a reliable locking in place upon closing of the holding body.

In an advantageous configuration, the passage region between the holding bodies is formed laterally with respect to the joint, in order to prevent an unintentional falling out of cards when the holding bodies are opened.

In an advantageous configuration, both holding bodies are formed so as to be movable with respect to each other, in order to achieve a large passage region between the holding bodies with only a slight actuation of the handgrips, thereby making possible a simple and quick exchanging of sample elements.

In an advantageous configuration, at least one hand grip is equipped with a hanging device, in order to keep the entire holder for sample cards in, for example, a display holder or in another carrying device.

An embodiment example of the invention is represented in the drawings, in which:

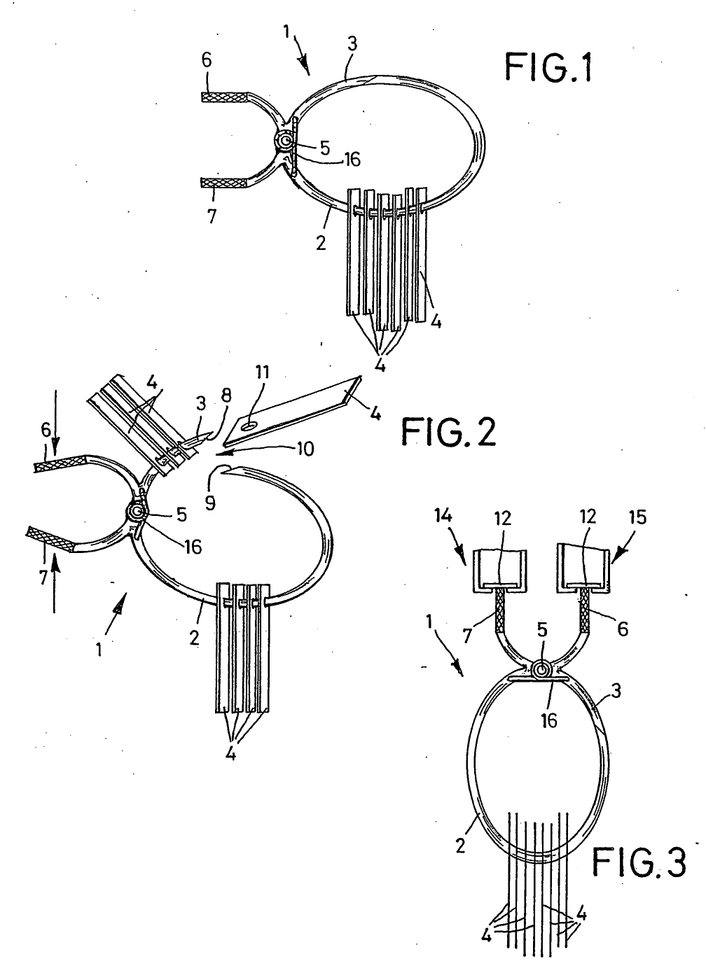

FIG. 1 shows the holder in a horizontally-held position in the closed state;

FIG. 2 shows the holder in a horizontally-held position in the opened state;

FIG. 3 shows the holder in a vertically-hanging position, again in the closed state.

Referring to FIG. 1, a holder for sample elements is represented, consisting essentially of two holding bodies 2 and 3. These holding bodies can consist, for example, of metal, e.g. round steel, or plastic, and can display, for example, a round or oval or polygonal cross section. These holding bodies 2, 3 have an outer diameter that is significantly smaller than cutouts 11 in sample elements, or rather is smaller than the cutouts 11 in color cards 4 that in this embodiment example are arranged on the holder 1; that is to say, the holding bodies 2, 3 are dimensioned such that they can be inserted through corresponding cutouts in the color cards 4, so that the color cards 4 can be threaded onto the holding bodies 2, 3. Obviously, eyelets or the like can also be arranged on the sample elements or the color cards 4 outside the actual elements or cards, which eyelets can be threaded onto the holding bodies 2, 3.

In addition, the holder 1 displays a joint 5 as well as handgrips 6, 7 for actuation of the holding bodies 2, 3. In this embodiment example, the handgrip 6 and the holding body 3 are formed as one piece, as are the handgrip 7 and the holding body 2. Upon a compression of the handgrips 6, 7 there follows—as can be seen in FIG. 2—a pressing apart of the holding bodies 2, 3, as is also the case with, for example, clothespins, and between the end faces 8, 9 of the holding bodies 2, 3 results a passage region, through which the color cards 4 can be guided and can be pushed onto the holding bodies 2, 3 with their cutouts 11.

Upon a releasing of the handgrips 6, 7 there occurs an automatic closing of the holding bodies 2, 3 due to a spring 16 formed in the joint 5, and the opening of the holding bodies 2, 3 upon a moving toward each other of the hand grips 6, 7 takes place against the spring force of the spring.

The end faces 8, 9 of the holding bodies 2, 3 are formed as beveled or crossed in a mutually-complementary manner, and thus produce a reliable and unbroken closing of the passage region 10, so that an unintentional falling out of color cards 4 with closed holding bodies 2, 3 is not possible. This is achieved through the fact that the end faces 8, 9 are not designed to bluntly meet each other when the holding bodies 2, 3 are closed, but rather to overlap each other.

In this embodiment example, the ring-like, i.e. closed, holding bodies 2, 3 have an oval basic shape, in order to enable a simple operability of the holder 1. However, the holding bodies can also have other geometric shapes, as for example a circular shape or any other appropriate shape.

In addition, at least one handgrip 6, 7 can be equipped with a hanging device in order to suspend the holder vertically in, for example, a display, so that thereby a good stowability of holders filled with color cards 4 can be achieved.

The opening or passage region 10 is not formed opposite the joint 5, i.e. not centrally, but rather latterally with respect to the joint 5, as is evident from the figures. This non-central positioning of the passage region 10 prevents in each position an unintentional falling off of the received color cards 4.

In an advantageous configuration, the handgrips 6, 7 are covered with slip-proof grip pieces, which in the figures are represented in a hatched manner. The grip pieces or handgrips can, in an advantageous configuration, be equipped with at least one hanging device in order to arrange the grip pieces in, for example, a rail system of a display. In FIG. 3, represented in a stylized manner at the ends of the hand grips 6, 7 are hangers 12, which are formed as lateral protrusions from the handgrips 6, 7 and can be hung in a corresponding rail system that, for example, can be arranged on a display stand or the like. This rail system is schematically represented together with rails 14, 15 in FIG. 3. Obviously, other types of rail systems or hanging systems can also be used for the holder shown.

1. Holder for sample elements, in particular for sample cards, with at least one holding body that penetrates a cutout or an eyelet fo the sample element or several sample elements, wherein a reception region for the sample elements, which reception region has two holding bodies (2, 3), at least one holding body (2, 3) being movable to obtain a ring-like closed configuration of the holding bodies (2, 3) in the closed position and a loading position forming a passage (10) between the holding bodies (2, 3), the holding bodies (2, 3) being provided on their side opposite to the reception region with at least one handgrip (6, 7).

2. Holder according to claim 1, wherein a joint (5) that is formed between the handgrips (6, 7) and the reception region, for the purpose of actuating at least one holding body (2, 3) upon actuation of at least one handgrip (6, 7).

3. Holder according to claim 1, wherein a spring-loaded joint (5) guiding the two holding bodies (2, 3), which joint is designed to close the holding bodies (2, 3) when the handgrips (6, 7) are not actuated.

4. Holder according to claim 1, wherein the holding bodies (2, 3) form an oval in their closed position.

5. Holder according to claim 1, wherein the holding bodies (2, 3), of which the facing end faces (8, 9) in the passage region (11) [sic] are formed in a beveled manner so as to complement each other.

6. Holder according to claim 1, wherein the passage region (10) between the holding bodies (2, 3), which region is formed laterally in relation to the joint (5).

7. Holder according to claim 1, wherein the holding bodies (2, 3) are each formed so as to be movable with respect to the other.

8. Holder according to claim 1, wherein at least one handgrip (6, 7) displays a hanging device for the holder (1).
